(19) United States
(12) Patent Application Publication
(10) Pub. No.: US 2007/0150245 A1
(43) Pub. Date: Jun. 28, 2007

(54) Method and apparatus for solving transport equations in multi-cell computer models of dynamic systems

(75) Inventors: Eric Douglas Pomraning, Madison, WI (US); Keith Jared Richards, Mount Horeb, WI (US); Peter Kelly Senecal, Middleton, WI (US); Tianliang Yang, Madison, WI (US)

Correspondence Address: CATERPILLAR/FINNEGAN, HENDERSON, L.L.P., 901 New York Avenue, NW, WASHINGTON, DC, 20001-4413, US

(73) Assignees: Caterpillar Inc.; Convergent Thinking, LLC.

(21) Appl. No.: 11/318,632

(22) Filed: Dec. 28, 2005

(51) Int. Cl. G06G 7/48

(52) U.S. Cl. 703/9

(57) ABSTRACT

Method and apparatus for modeling a dynamic system include a digital computer and a multi-cell system dynamics modeling program stored in the computer. The modeling program has an iterative calculation routine for calculating one or more thermophysical values for each model cell. The routine employs one or more initial iterations using the latest calculated thermophysical values to solve transport equations between each individual cell of at least a portion of the multi-cell model and adjacent cells, to provide intermediate thermophysical values, and a final iteration using the intermediate thermophysical values to provide the thermophysical values representative of each individual cell.

### TECHNICAL FIELD

The present disclosure relates generally to a method and apparatus for implementing multi-cell computer models of dynamic systems. More particularly, the present disclosure relates to a method for solving transport equations in multi-cell computational fluid dynamics models, and apparatus for performing the method.

### BACKGROUND

Modeling dynamic systems, including fluid dynamic systems, using computers, particularly high-speed digital computers, is a well known and cost efficient way of predicting system performance for both steady thermophysical and transient conditions without having to physically construct and test an actual system. A benefit to computer modeling is that the effect on performance of changes in system structure and composition can be easily assessed, thereby leading to optimization of the system design prior to construction of a commercial prototype.

Known modeling programs generally use a “multi-cell” approach, where the structure to be modeled is divided into a plurality of discrete volume units (cells). Typically, the computer is used to compute thermophysical values of the fraction of the system within the cell, such as, e.g., mass, momentum, and energy values, as well as additional system performance parameters such as density, pressure, velocity, and temperature, by solving the conservation equations governing the transport of, e.g., thermophysical units from the neighboring cells or from a system boundary. One skilled in the art would understand that for a geometric system model using Cartesian coordinates, and absent a system boundary, each cell would have six cell neighbors positioned adjacent the six faces of the cube-shaped cell. An example of a computational fluid dynamics modeling program is the MoSES Program available from Convergent Thinking LLC, Madison, Wis. However, improvements are possible and desirable in existing modeling programs.

For example, MoSES primarily uses the pointwise Gauss-Seidel iterative method for solving the governing transport conservation equations (e.g., momentum, energy, mass etc.). As with many efficient iterative methods, however, Gauss-Seidel only conserves transported quantities to the specified convergence tolerance. Ideally, the transported quantities should be conserved exactly.

The reason that Gauss-Seidel fails to conserve exactly is also the reason for its efficiency. When solving the discretized governing equations, the Gauss-Seidel method sweeps through all of the computational cells one by one and updates each cell's transported quantities based on fluxes at cell faces calculated from its own cell thermophysical values and the thermophysical values of its neighboring, adjacent cells. This process, which is called an“siteration,” is repeated until the changes in thermophysical values of the cells for successive iterations are smaller than the specified convergence criteria.

Gauss-Seidel is efficient because it uses the most current iteration values, if possible, for the neighboring cells when solving for thermophysical values for a particular cell. In other words, if an adjacent cell has already been updated for the current iteration, its updated thermophysical values will be used for calculating the new thermophysical values for the particular cell currently being updated. Conversely, if the adjacent cell has not been updated, Gauss-Seidel will use the thermophysical values from the previous iteration for calculating the new thermophysical values for the particular cell. The conservation problem occurs because the current values are used for the adjacent cell that, for net flux out of the adjacent cell and into the cell being updated, may result in a different calculated flux leaving the adjacent cell than is entering the cell being updated.

### SUMMARY OF THE INVENTION

A method for solving transport equations between neighboring cells in a multi-cell computational systems dynamics model includes performing at least one initial iteration, wherein one or more intermediate thermophysical values are sequentially calculated for each individual model cell in at least a portion of the multi-cell model by solving the transport equations using the latest calculated thermophysical values for each cell adjacent the individual cell during the iteration. The method thereafter includes performing a final iteration for each individual cell in the model portion using the intermediate thermophysical values for each adjacent cell in the transport equations, for calculating one or more thermophysical values for each model portion cell.

In accordance with another aspect, an apparatus for modeling a dynamic system includes a digital computer and a multi-cell dynamics modeling program stored in the computer. The program includes an iterative calculation routine for calculating one or more thermophysical values of each cell in at least a portion of the multi-cell model. The routine employs one or more initial iterations using the latest calculated thermophysical values to solve transport equations between each individual cell of at least a portion of the multi-cell model and adjacent cells, to provide intermediate thermophysical values, and a final iteration using the intermediate thermophysical values to provide the thermophysical values representative of each individual cell of the multi-cell model portion.

It is to be understood that both the foregoing general description and the following detailed description are exemplary and explanatory only and are not restrictive of the invention, as claimed.

### BRIEF DESCRIPTION OF THE DRAWINGS

FIG. 1 is a schematic illustration of an exemplary apparatus for performing computational system dynamics modeling in accordance with the present invention;

FIG. 2 is a flow chart of an exemplary iterative computational routine in accordance with the present invention.

FIG. 3 is a schematic depiction of cells in a fixed geometry Cartesian fluid dynamics model, showing adjacent cells;

FIG. 4A is a schematic illustration of an internal combustion engine component to be modeled; and

FIG. 4B is a schematic of a detail of the multi-cell grid structure of the computational fluid dynamics model for the engine component in FIG. 4A.

### DETAILED DESCRIPTION

Reference will now be made in detail to the present exemplary embodiments of the invention, examples of which are illustrated in the accompanying drawings. Wherever possible, the same reference numbers will be used throughout the drawings to refer to the same or like parts.

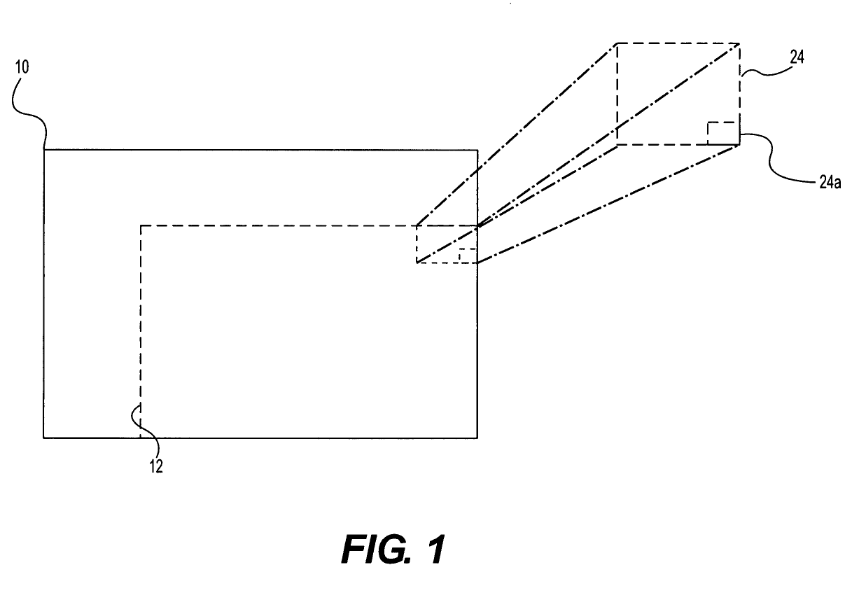

As described herein, an apparatus for solving transport equations between adjacent cells in a multi-cell computational dynamics model to provide one or more thermophysical values for each cell includes a digital computer. As embodied herein, and with initial reference to FIG. 1, digital computer 10 is shown programmed with multi-cell systems dynamics program 12, both shown schematically. Digital computer 10 can be a general purpose programmable computer suitable for handling large scientific and engineering computational system dynamics programs, such as an AMD “Opteron” computer. Digital computer 10 can also be a special purpose computer where the multi-cell system dynamics program 12 is “hard wired,” as one of ordinary skill in the art would understand.

Multi-cell dynamics program 12 can be any of various types suited for modeling dynamic systems. A suitable program for modeling dynamic systems, including gas-type fluid dynamic systems, is the MoSES program available from Convergent Thinking LLC, Madison, Wis.

The computational fluid dynamics program model may include an iterative calculation routine for calculating one or more thermophysical values of each cell. As embodied herein and with reference again to FIG. 1, computational fluid dynamics program 12 includes a calculation routine schematically depicted at 24 that iteratively solves, e.g., the mass, momentum, and energy transport equations between an individual cell and its adjacent cells, and then calculates the new thermophysical values for that individual cell. These transport equations are well-known to those skilled in the art of modeling dynamic systems.

One of ordinary skill in the art also would understand that during one iteration of calculation routine 24, the transport equations can be solved and the thermophysical values of each individual cell in the model can be updated in a specific computational time period, such as at the end of each successive time increment in a transient. Alternatively, only a portion of the cells in the model could be updated during a particular computational time period, such as the cells in regions with expected large gradients in thermophysical values, depending on the nature of the system being modeled.

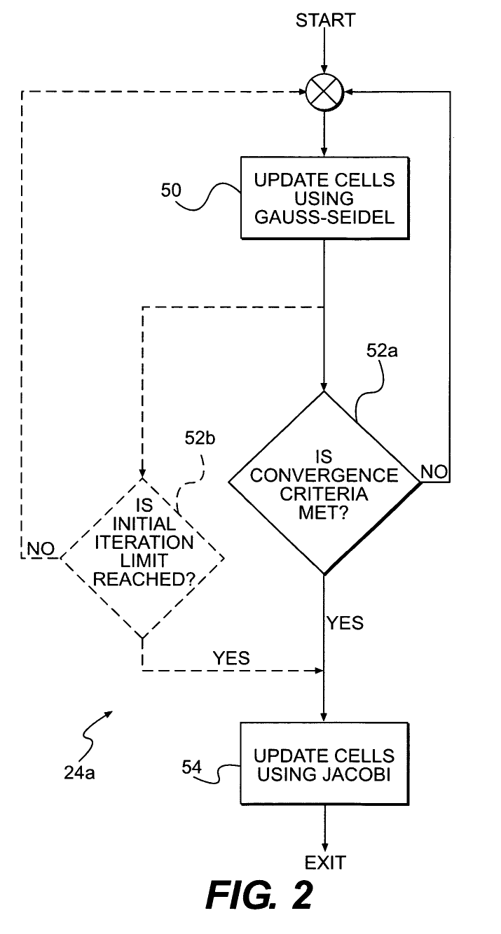

Further, the calculation routine may perform one or more initial iterations in which the latest thermophysical values for the adjacent cells are used in solving the transport equations. As embodied herein, and with reference to the flow chart in FIG. 2, calculation routine 24 employs a subroutine 24a that uses the Gauss-Seidel computational method for the initial iterations. A precise number of such initial iterations can be set in advance or can be determined internally by allowing the initial iterations to proceed until a preset convergence is met. For example, a suitable convergence criteria could be when the change in thermophysical values in a cell or group of cells between successive iterations becomes less than a specified amount. In either case, at the conclusion of the initial iterations, the thermophysical values for all applicable cells that have been calculated are temporarily stored in memory and are regarded as “intermediate”and not the final values to be assigned to the respective cells.

As can be understood from a schematic flow chart for subroutine 24a depicted in FIG. 2, one or more initial iterations are performed in block 50 to generate thermophysical values for each individual cell for at least a portion of the system model using the latest calculated thermophysical values for the adjacent cells. As mentioned previously, it may be preferred to perform the one or more initial iterations using a non-conserving iterative method, such as Gauss-Sefidel. Following each initial iteration a decision is made, as represented in blocks 52a or 52b, whether to perform further initial iterations or to advance to a final iteration. As depicted by block 52a, this decision could be based on a preset convergence criteria using, e.g., the difference in one or more thermophysical values for a representative cell or cells between successive initial iterations (thereby requiring at least two initial iterations), or between a single initial iteration and thermophysical values existing at the start of the routine, which would require only a single initial iteration. Alternatively, block 52b can be used to provide the decision based on a running total of initial iterations as compared to a preset number. Other convergence schemes are possible.

Still further, in accordance with one aspect of the present invention, the calculation routine performs a final iteration using the intermediate thermophysical values from the last initial iteration to generate the thermophysical values for all applicable cells. As embodied herein, calculation subroutine 24a performs a Jacobi calculation method for the final iteration. One of ordinary skill in the art would understand that the Jacobi calculation method, while less efficient than the Gauss-Seidel method, conserves mass, momentum and energy flux transferred between the adjacent cells and the individual cell whose thermophysical values are being updated.

In the FIG. 2 embodiment, the final iteration is represented by block 54. One skilled in the art would understand that it may be preferred to store the intermediate thermophysical values calculated by the last initial iteration in a memory file separate from that intended to hold the final thermophysical values to ensure accuracy of the calculations in block 54. It may also be preferred that the final iterations be performed using a Jacobi calculational scheme.

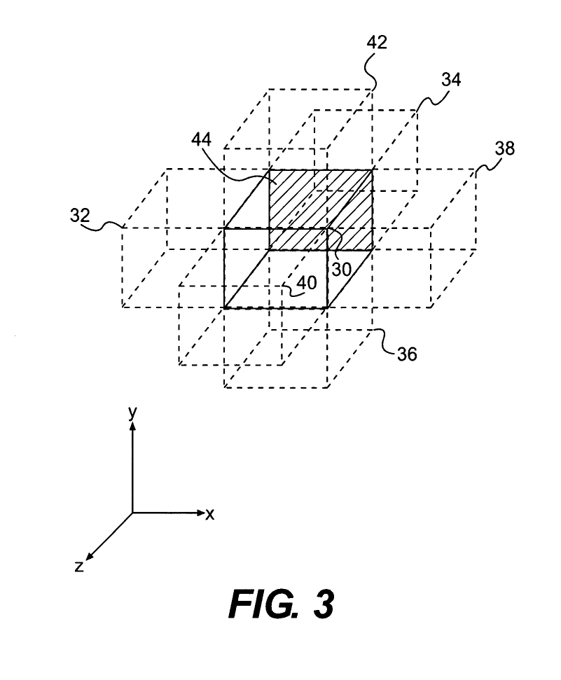

An appreciation of the problem with relying exclusively on the Gauss-Seidel type computational methods for solving transport equations for a compressible fluid system model can be obtained by considering the schematic three dimensional (“3D”) depiction of adjacent cells in a fixed geometry Cartesian grid model shown in FIG. 3. One of ordinary skill in the art would understand that when using the Gauss-Seidel method, a subroutine would calculate the thermophysical values of cells sequentially, one at time, in some prescribed order. Thus, if the prescribed order is to first index along the X axis, then index along the Z axis, and finally along the Y axis, at the time of the calculation of thermophysical values for cell 30 during a particular iteration, the thernophysical values for cells 32, 34, and 36 would have already have been computed by that subroutine. In comparison, cells 38, 40, and 42 would still have thermophysical values corresponding to the previous iteration. In such a case, for example during the update of cell 34, the mass flux through the common cell face 44 bounding cells 30 and 34 would have been based on the densities existing in those cells at the end of the previous iteration when cells 34 and 30 were last updated. However, the mass flux through the same cell face 44 calculated during the update of cell 30 would have been based on an updated density in cell 34, but the density in cell 30 would still be the value calculated in the previous iteration. For relatively sharp density gradients and/or transients, the differences in calculated mass flux through cell face 44 can be significant, possibly leading to non-conservation and differences in predicted performance with different indexing protocols. The disclosed system is intended to mitigate this problem by providing in subroutine 24a a final iteration using a computational method that conserves transferred thermophysical values.

### INDUSTRIAL APPLICABILITY

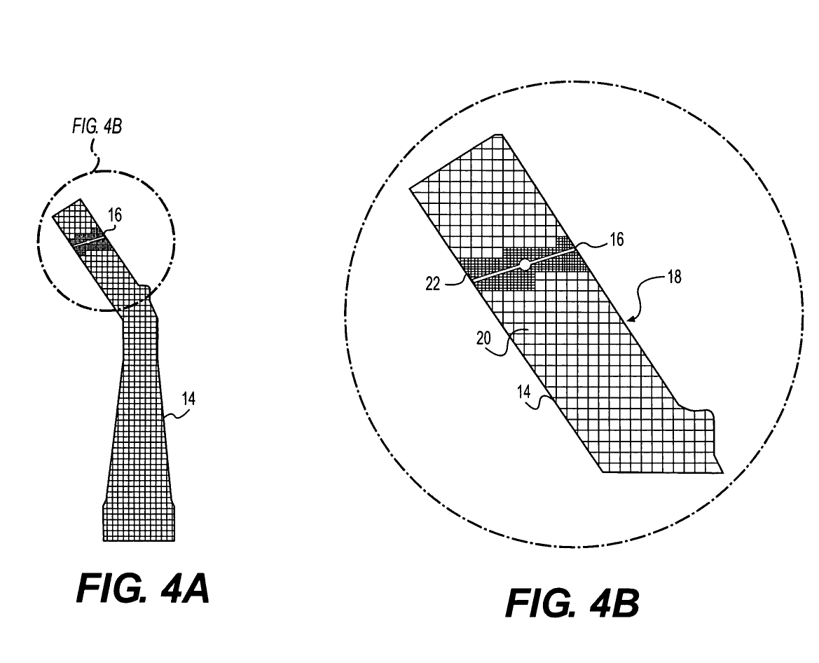

FIG. 4A is a schematic section representation of duct 14 having a movable (rotatable) plate 16, for use in an internal combustion engine (not shown). FIG. 4B is a detail of FIG. 4A and shows schematically a superimposed fixed geometric model grid 18 representing an array of three dimensional computational cells 20 and 22 for predicting performance (flow, pressure, temperature, etc.) in duct 14 for various operating conditions corresponding to movement and/or different positions of moveable plate 16 during transient and/or quasi-steady thermophysical operations. Cells 20 and 22 as depicted are geometrically regular (cubic), except possibly at the system boundaries, and can be described using a Cartesian coordinate system. Although all the computational cells may be of the same size, computational system dynamics model 12 may utilize cells of different size, including larger cells 20 that make up the bulk of the model as well as “embedded,” smaller cells 22 that are located in the regions of expected sharp gradients in gas pressure, velocity, and/or temperature such as in the immediate vicinity of moveable plate 16.

During operation of program 12, particularly calculation routine 24 and subroutine 24a, on the model of intake pipe 14, represented by grid 18, the transport equations governing thermophysical value fluxes between individual cells, such as cells 22, and their adjacent cells would be iteratively solved to update the thermophysical values (e.g., mass, momentum, etc.) for the individual cells. In accordance with one embodiment, subroutine 24a would perform one or more initial iterations using a non-conserving method, such as Gauss-Seidel, to provide “intermediate” thermophysical values for the individual cells until convergence criteria were satisfied. The “final” thermophysical values for the individual cells would then be calculated by subroutine 24a in a further iteration using a conserving calculation method, such as a Jacobi computation method, to conserve transferred thermophysical values.

It may be preferred that the method and apparatus of the present invention be used in conjunction with the Method and Apparatus for Implementing Multi-Grid Computation for Multi-Cell Computer Models with Embedded Cells disclosed in U.S.S.N. ______ (08350.5642) filed concurrently herewith.

It may also be preferred that the method and apparatus of the present invention be used in conjunction with the Method and Apparatus for Treating Moving Boundaries in Multi-Cell Computer Models of Fluid Dynamic Systems disclosed in U.S.S.N. ______ (08350.5643) filed concurrently herewith.

It may further be preferred that the method and apparatus of the present invention be used in conjunction with the Method and Apparatus for Automated Grid Formation in Multi-Cell System Dynamics Models disclosed in U.S.S.N. ______ (8350.5645) filed concurrently herewith.

Other embodiments will be apparent to those skilled in the art from consideration of the specification and practice of the disclosed method and apparatus. It is intended that the specification and examples be considered as exemplary only, with a true scoping indicated by the following claims and their equivalence.

What is claimed is:

1. Method for solving transport equations between neighboring cells in a multi-cell computational dynamics model, the method comprising:
performing at least one initial iteration wherein one or more intermediate thermophysical values are sequentially calculated for each individual model cell in at least a portion of the multi-cell model by solving the transport equations using the latest calculated thermophysical values for each cell adjacent the individual cell during said iteration; and
performing a final iteration for the time increment for each cell in the model portion using the intermediate thermophysical values for each adjacent cell in the transport equations, for calculating one or more thermophysical values for each model portion cell.

2. The method as in claim 1, wherein the multi-cell dynamics model is a fluid dynamics model, and wherein the thermophysical values are one or more of pressure, temperature, density, and velocity.

3. The method as in claim 1, wherein during the final iteration one or more of mass, momentum, and energy are conserved during the calculated flux transport between the individual cell and adjacent cells.

4. The method as in claim 1, wherein the one or more initial iterations use a non-conserving iterative calculation method.

5. The method as in claim 1, wherein the final iteration uses a Jacobi calculation method.

6. The method as in claim 4, wherein the final iteration uses a Jacobi calculation method.

7. The method as in claim 1, wherein the initial iterations are continued until the difference between successive calculated intermediate thermophysical values for one or more of the individual cells is below a preselected amount.

8. The method as in claim 1, wherein the at least one initial iteration and the final iteration are performed on substantially all the cells in the multi-cell model.

9. The method as in claim 4, wherein the one or more initial iterations use a Gauss-Seidel calculation method.

10. In an iterative calculation method for solving transport equations using a non-conserving iterative calculation method to determine one or more thermophysical values of at least a portion of the cells in a multi-cell fluid dynamic system model, the improvement comprising:
storing the thermophysical values calculated from a last conserving iterative calculation as intermediate thermophysical values; and
solving the transport equations for the cells in the model portion in a final iteration using only the intermediate thermophysical values, whereby at least one of mass, momentum and energy are conserved.

11. The improved iterative calculation method as in claim 10, wherein a Jacobi calculational method is used in the final iteration.

12. The improved calculation method as in claim 10, wherein the fluid dynamics system model includes a fixed geometric grid.

13. Apparatus for modeling a dynamic system comprising:
a digital computer; and
a multi-cell system dynamics modeling program stored in said computer, said program including an iterative calculation routine for calculating one or more thermophysical values for each individual model cell in at least a portion of a multi-cell model,
wherein said routine employs one or more initial iterations using the latest calculated thermophysical values to solve transport equations between each individual cell of at least a portion of the multi-cell model and adjacent cells, to provide intermediate thermophysical values, and a final iteration using the intermediate thermophysical values to provide the thermophysical values representative of said each individual cell.

14. The apparatus as in claim 13, wherein the dynamics modeling program is a fluid dynamics modeling program, and wherein the thermophysical values are one or more of pressure, temperature, density, and velocity.

15. The apparatus as in claim 13, wherein the iteration calculation routine is for solving one or more of mass, momentum, and energy transport equations between said each individual cell and respective adjacent cells in the model.

16. The apparatus as in claim 15, wherein in the final iteration, one or more of mass, momentum, and energy are conserved in the transport calculations.

17. The apparatus as in claim 14, wherein the fluid dynamics program model is a model of compressible gas flow in a component of an internal combustion engine.

18. The apparatus as in claim 13, wherein the iterative calculation routine uses a Gauss-Seidel calculation method for the one or more initial iterations and a Jacobi calculation method for the final iteration.

19. The apparatus as in claim 13, wherein the iterative calculation routine uses a final iteration that conserves one or more of mass, momentum, and energy transported between said each individual cell and respective adjacent cells.

20. The apparatus as in claim 13, wherein the system model includes a fixed geometric grid.
